(19) United States
(12) Patent Application Publication
(10) Pub. No.: US 2004/0041513 A1
(43) Pub. Date: Mar. 4, 2004

(54) Cathode ray tube

(75) Inventors: Masaki Kawasaki, Osaka (JP); Naoki Yamauchi, Osaka (JP); Kenji Saito, Osaka (JP); Tetsurou Ozawa, Osaka (JP)

Correspondence Address: Merchant & Gould P.C., P.O. Box 2903, Minneapolis, MN, 55402-0903, US

(73) Assignee: Matsushita Electric Industrial Co., Ltd., Osaka (JP)

(21) Appl. No.: 10/625,224

(22) Filed: Jul. 22, 2003

(30) Foreign Application Priority Data
Jul. 23, 2002 (JP) 2002-213409

(51) Int. Cl. H01J 31/00

(52) U.S. Cl. 313/479

(57) ABSTRACT

An internal magnetic shield is joined to a color selection electrode structure including a color selection electrode, a pair of longer side frames supporting the color selection electrode with tension being applied and a pair of shorter side frames joined to the pair of longer side frames. Magnetic shielding members inclined at an inclination angle θ (θ≠0°) to a tube axis are provided on lateral surfaces of shorter sides of the internal magnetic shield. Phosphor screen side edges of the magnetic shielding members are located between the color selection electrode and a plane that passes through color selection electrode side ends of the pair of shorter side frames and is perpendicular to the tube axis. In this manner, magnetic shielding characteristics can be improved against not only a transverse magnetic field but a tube axis magnetic field. Consequently, mis-landing of the electron beam caused by terrestrial magnetism can be prevented, thereby providing a cathode ray tube with reduced color displacement in a screen.

### BACKGROUND OF THE INVENTION

1. Field of the Invention

The present invention relates to a cathode ray tube including an internal magnetic shield.

2. Description of Related Art

As shown in FIG. 8, a cathode ray tube 100 includes a panel 101, a funnel 102 and a neck 103. The panel 101 is provided with a phosphor screen 104. In the neck 103, an electron gun 105 for emitting an electron beam 106 is sealed. On an outer periphery of the funnel 102, a deflection yoke 107 is disposed for deflecting the electron beam 106 emitted from the electron gun 105. Further, in the cathode ray tube 100, a color selection electrode 108 spaced at a predetermined distance from the phosphor screen 104, a frame 109 for supporting this color selection electrode 108, and an internal magnetic shield 110 are arranged in this order from the phosphor screen 104 toward the side of the electron gun 105.

The electron beam 106 emitted from the electron gun 105 is deflected horizontally and vertically by the deflection yoke 107, passes through the color selection electrode 108 and reaches the phosphor screen 104, thus producing an image.

When the electron beam is irradiated at a position different from a desired position, this phenomenon is called “mis-landing.” The occurrence of mis-landing causes an image deterioration called color displacement. One of the factors responsible for the occurrence of mis-landing is an external magnetic field such as terrestrial magnetism. When the external magnetic field acts on the electron beam, a path of the electron beam is bent, thus causing the mis-landing. Since the direction of the external magnetic field acting on the cathode ray tube differs depending on an installation orientation of the cathode ray tube, the amount of mis-landing also differs depending on this installation orientation.

Therefore, in order to achieve a stable image display constantly irrespective of the installation orientation, it is necessary to minimize the influence of the external magnetic field.

Accordingly, as shown in FIG. 8, the internal magnetic shield 110 formed of a magnetic material or the like conventionally is used to surround the path of the electron beam, thereby absorbing the external magnetic field and acting as a shield, so that the influence of the external magnetic field on the electron beam is reduced. Such shielding against the external magnetic field is called the magnetic shielding characteristics.

A conventional cathode ray tube for improving the magnetic shielding characteristics is disclosed in JP 2001-23533 A. In this conventional cathode ray tube, in parallel with a tube axis, magnetic pieces further are joined to shorter sides of an internal magnetic shield on a phosphor screen side. They act as a shield against the magnetic field from a lateral side of a frame, thereby improving the magnetic shielding characteristics against the magnetic field parallel with the phosphor screen.

However, this conventional cathode ray tube cannot provide a sufficient shield against the external magnetic field depending on the installation orientation of the cathode ray tube, and there have been many cases where the color displacement occurs in the screen.

### SUMMARY OF THE INVENTION

The present invention was made to solve the problem described above, and the object of the present invention is to provide a cathode ray tube that achieves an excellent image display by improving further magnetic shielding characteristics against an external magnetic field so as to reduce mis-landing of an electron beam.

A cathode ray tube according to the present invention includes a panel having a phosphor screen, an electron gun for emitting an electron beam toward the panel, a color selection electrode having electron beam passing apertures, a pair of longer side frames for supporting the color selection electrode with a tension being applied, a pair of shorter side frames joined to the pair of longer side frames, and an internal magnetic shield. Magnetic shielding members further are provided on lateral surfaces of shorter sides of the internal magnetic shield. The magnetic shielding members are inclined at an inclination angle θ (θ≠0°) to a tube axis, and edges of the magnetic shielding members on a side of the phosphor screen are located between the color selection electrode and a plane that passes through ends of the pair of shorter side frames on a side of the color selection electrode and is perpendicular to the tube axis.

### BRIEF DESCRIPTION OF THE DRAWINGS

FIG. 1 is a sectional view showing a cathode ray tube according to an embodiment of the present invention.

FIG. 2 is an exploded perspective view showing an internal magnetic shield, an electron shield and a color selection electrode structure of a cathode ray tube according to an embodiment of the present invention.

FIG. 3A is a sectional view schematically showing an internal magnetic shield and a color selection electrode structure for describing an effect on a transverse magnetic field in a cathode ray tube according to an embodiment of the present invention.

FIG. 3B is a sectional view schematically showing an internal magnetic shield and a color selection electrode structure for describing an effect on a transverse magnetic field in a cathode ray tube according to a comparative example.

FIG. 4A is a sectional view schematically showing an internal magnetic shield and a color selection electrode structure for describing an effect on a tube axis magnetic field in a cathode ray tube according to an embodiment of the present invention.

FIG. 4B is a sectional view schematically showing an internal magnetic shield and a color selection electrode structure for describing an effect on a tube axis magnetic field in a cathode ray tube according to a comparative example.

FIG. 5 is an exploded perspective view showing dimensions of each portion in an internal magnetic shield, an electron shield and a color selection electrode structure in an experiment conducted on an effect of a cathode ray tube according to an embodiment of the present invention.

FIG. 6 is a perspective view showing a variation of an internal magnetic shield of a cathode ray tube according to an embodiment of the present invention.

FIGS. 7A to 7C are perspective views showing variations of a magnetic shielding member according to an embodiment of the present invention.

FIG. 8 is a sectional view showing a conventional cathode ray tube.

### DESCRIPTION OF THE PREFERRED EMBODIMENTS

In the above-described cathode ray tube of the present invention, since the edges of the magnetic shielding members on the side of the phosphor screen are located between the color selection electrode and the plane that passes through the ends of the pair of shorter side frames on the side of the color selection electrode and is perpendicular to the tube axis, it is possible to provide a shield to prevent a magnetic field (hereinafter, referred to as a “transverse magnetic field”) parallel with a plane perpendicular to the tube axis (hereinafter, referred to as a “tube plane”) from entering into the vicinity of the color selection electrode.

Also, since the magnetic shielding members are not parallel with the tube axis but inclined at an inclination angle θ (θ≠0°) to the tube axis, the direction of magnetic flux, which is generated by a magnetic field in the tube axis direction perpendicular to the tube plane (hereinafter, referred to as a “tube axis magnetic field”), in the vicinity of the phosphor screen side edges of the magnetic shielding members can be made substantially parallel with a path of the electron beam that is deflected to this vicinity. Thus, it is possible to reduce the magnetic flux crossing the electron beam, thereby reducing mis-landing.

Furthermore, since the magnetic shielding members are provided on the lateral surfaces of the shorter sides of the internal magnetic shield, a magnetic resistance between the internal magnetic shield and the magnetic shielding members is reduced. Accordingly, the tube axis magnetic field can pass through the internal magnetic shield and the magnetic shielding members more easily, allowing a further reduction of mis-landing.

As a result, in the cathode ray tube of the present invention, the magnetic shielding characteristics improve against not only the transverse magnetic field but also the tube axis magnetic field.

Consequently, since the variation of the electron beam path caused by the terrestrial magnetism can be suppressed considerably, the mis-landing can be prevented, making it possible to provide a cathode ray tube that prevents the color displacement in the screen.

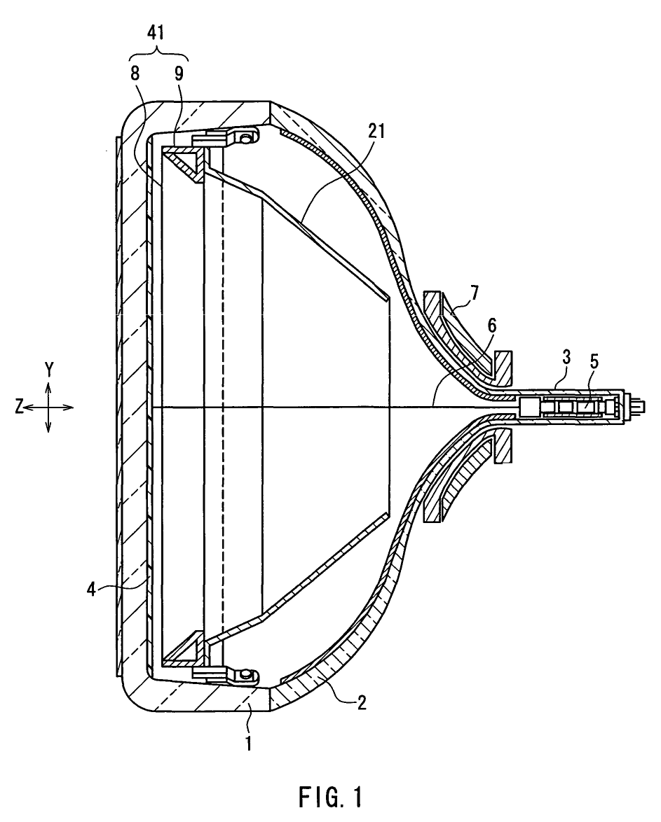

The following is a description of an embodiment of a cathode ray tube according to the present invention, with reference to FIGS. 1 to 7.

First, a basic structure of an embodiment of the cathode ray tube according to the present invention will be described referring to FIG. 1.

As shown in FIG. 1, a cathode ray tube in accordance with an embodiment of the present invention includes a panel 1, a funnel 2 and a neck 3. The panel 1 is provided with a phosphor screen 4. An electron gun 5 for emitting an electron beam is sealed in the neck 3. On an outer periphery of the funnel 2, a deflection yoke 7 is disposed for deflecting the electron beam 6 emitted from the electron gun 5. Further, a color selection electrode structure 41 including a color selection electrode (a shadow mask) 8 and a frame 9 for supporting this color selection electrode 8 is arranged on the side of the electron gun 5 at a predetermined distance from the phosphor screen 4. Moreover, an internal magnetic shield 21 for shielding the electron beam 6 from an external magnetism is arranged inside the funnel 2 and on the side of the electron gun 5 with respect to the color selection electrode structure 41. In addition, an electron shield acting as a shield against an electron beam is arranged between the color selection electrode structure 41 and the internal magnetic shield 21.

In the following, a cathode ray tube according to an embodiment of the present invention, in particular, an internal magnetic shield, a color selection electrode structure and an electron shield of the cathode ray tube, will be described with reference to the accompanying drawings.

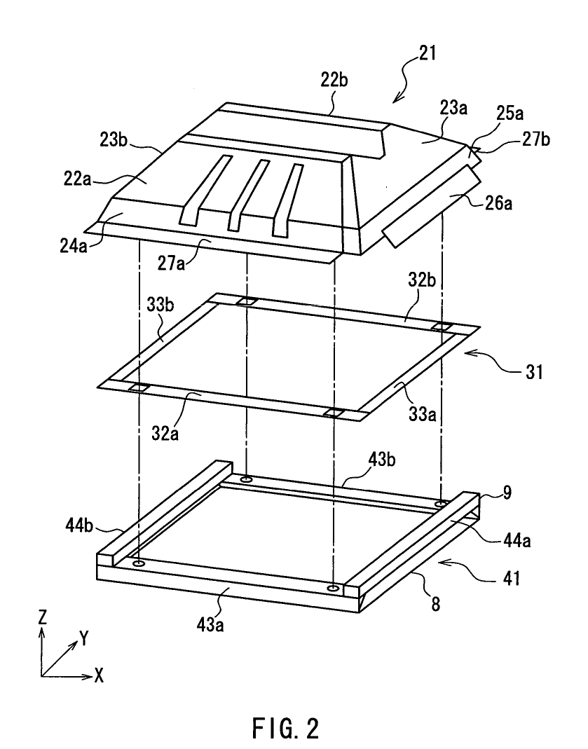

FIG. 2 is an exploded perspective view showing the internal magnetic shield 21, the electron shield 31 and the color selection electrode structure 41 in the cathode ray tube according to an embodiment of the present invention. In the following description, a Z axis indicates a tube axis, and an X axis and a Y axis indicate two axes perpendicular to each other within a plane orthogonal to the Z axis. The X axis corresponds to a direction in which a longer side of the panel 1 extends, and the Y axis corresponds to a direction in which a shorter side thereof extends.

As shown in FIG. 2, the internal magnetic shield 21 formed of a magnetic material is constituted mainly by longer-side magnetic shield portions 22a and 22b (portion 22b is not visible in FIG. 2) and shorter-side magnetic shield portions 23a and 23b, and these magnetic shield portions 22a, 22b, 23a and 23b are inclined with respect to the Z axis. Further, longer-side skirt portions 24a and 24b (portion 24b is not visible in FIG. 2) are formed so as to extend from ends of the longer-side magnetic shield portions 22a and 22b on the side of the color selection electrode 8, and shorter-side skirt portions 25a and 25b (portion 25b is not visible in FIG. 2) are formed so as to extend from ends of the shorter-side magnetic shield portions 23a and 23b on the side of the color selection electrode 8. It should be noted that the longer-side skirt portions 24a and 24b and the shorter-side skirt portions 25a and 25b are substantially perpendicular to the XY plane.

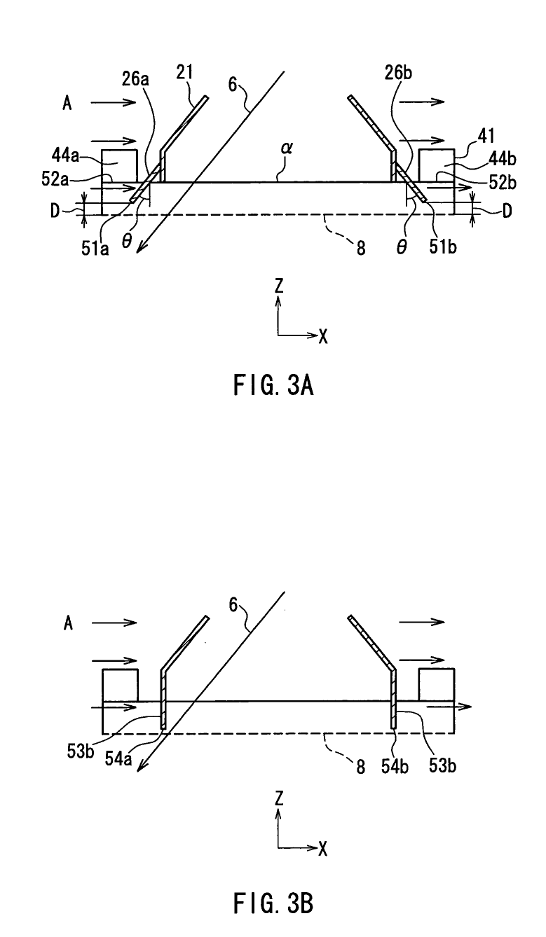

Furthermore, plate-like magnetic shielding members 26a and 26b (26b is not shown) formed of a magnetic material are welded to the shorter-side skirt portions 25a and 25b so as to form an inclination angle θ (see FIG. 3A, θ≠0°) with the Z axis (or the YZ plane). In other words, the magnetic shielding members 26a and 26b are provided in such a manner as to be spaced farther from each other toward the side of the color selection electrode 8. In an example, the inclination angle θ of the magnetic shielding members 26a and 26b was set to be 15° with respect to the YZ plane.

Moreover, horizontal skirt portions 27a and 27b substantially in parallel with the XY plane are formed so as to extend from ends of the longer-side skirt portions 24a and 24b on the side of the color selection electrode 8.

Next, the electron shield 31 will be described. The electron shield 31 acts as a shield against an over-deflected electron beam, thus preventing halation caused by a reflected beam. This electron shield 31 may be a thin plate member formed of a magnetic material in the shape of a rectangular frame and include longer sides 32a and 32b and shorter sides 33a and 33b. Incidentally, the electron shield 31 also may be formed of a non-magnetic material.

Now, the color selection electrode structure 41 will be described. The color selection electrode structure 41 includes the color selection electrode 8 having a plurality of electron beam passing apertures, a pair of longer side frames 43a and 43b whose side edges support the color selection electrode 8 while applying tension in the Y-axis direction to the color selection electrode 8, and a pair of shorter side frames 44a and 44b joined to electron-gun-side surfaces of the pair of longer side frames 43a and 43b and supporting the pair of longer side frames 43a and 43b.

The internal magnetic shield 21, the electron shield 31 and the color selection electrode structure 41 are welded and fixed together in this order from the electron gun 5 toward the phosphor screen 4 and then sealed in the cathode ray tube.

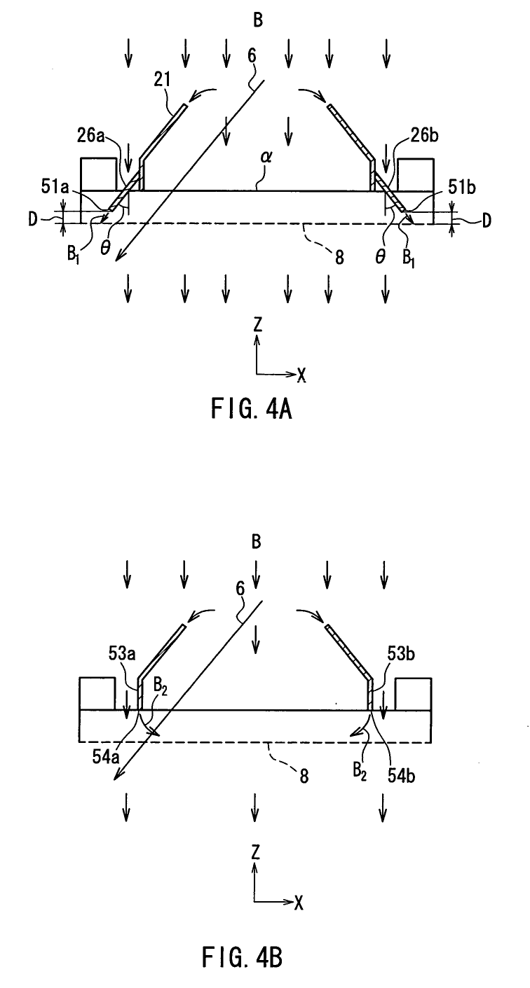

Next, effects of the cathode ray tube according to the present embodiment will be described referring to FIGS. 3A, 3B, 4A and 4B. Each of FIGS. 3A to 4B schematically shows a cross-section of the internal magnetic shield and the color selection electrode structure, for describing the effect on a transverse magnetic field referring to FIGS. 3A and 3B and the effect on a tube axis magnetic field referring to FIGS. 4A and 4B.

First, the shielding effect against the transverse magnetic field will be described.

As shown in FIG. 3A, in the tube axis (Z axis) direction, phosphor screen side edges (in other words, edges on the side of the color selection electrode 8) 51a and 51b of the magnetic shielding members 26a and 26b provided in the internal magnetic shield 21 are located between the color selection electrode 8 and a plane that passes through ends 52a and 52b of the pair of shorter side frames 44a and 44b on the side of the color selection electrode 8 and is perpendicular to the tube axis (a plane α). The magnetic shielding members 26a and 26b are inclined at an angle θ to the tube axis, and, in the X axis direction, their phosphor screen side edges 51a and 51b are located preferably within the range of the shorter side frames 44a and 44b.

As shown in FIG. 3A, since the phosphor screen side edges 51a and 51b of the magnetic shielding members 26a and 26b according to the present embodiment are located between the plane α and the color selection electrode 8, it is possible to prevent magnetic flux A of the transverse magnetic field from entering the tube axis side from between the color selection electrode 8 and the shorter side frames 44a and 44b. In this way, the shielding effect against the magnetic flux A of the transverse magnetic field can be obtained, making it possible to prevent the electron beam 6 from being bent by the Lorentz force of the magnetic flux A of the transverse magnetic field.

In particular, it is preferable that a distance D along the tube axis direction between the color selection electrode 8 and the phosphor screen side edges 51a and 51b of the magnetic shielding members 26a and 26b is 30 mm or smaller, because the shielding effect against the transverse magnetic field improves further so as to reduce the mis-landing of the electron beam 6.

In the case where magnetic shielding members 53a and 53b are provided in parallel with the tube axis as in a comparative example shown in FIG. 3B, when phosphor screen side edges (in other words, edges on the side of the color selection electrode 8) 54a and 54b of the magnetic shielding members 53a and 53b are extended to the vicinity of the color selection electrode 8 as in FIG. 3A, the magnetic shielding members 53a and 53b become likely to interfere with the electron beam 6. On the other hand, in the present embodiment shown in FIG. 3A, the magnetic shielding members 26a and 26b are inclined at the inclination angle θ to the tube axis so as to be spaced farther from each other toward the side of the color selection electrode 8, and therefore, even when their phosphor screen side edges 51a and 51b are extended to the vicinity of the color selection electrode 8, the magnetic shielding members 26a and 26b do not interfere with the electron beam 6. It is particularly preferable that, in the X axis direction, the phosphor screen side edges 51a and 51b are located within the range of the shorter side frames 44a and 44b as described above, because the interference with the electron beam 6 can be reduced further.

As described above, the magnetic shielding members 26a and 26b of the present embodiment can achieve a great shielding effect against the transverse magnetic field while avoiding a collision with the electron beam 6.

Next, the shielding effect against the tube axis magnetic field will be described.

As shown in FIG. 4A, since the magnetic shielding members 26a and 26b according to the present embodiment are inclined at the inclination angle θ to the tube axis, they also can act as a shield against magnetic flux B of the tube axis magnetic field.

In the case where the magnetic shielding members 53a and 53b are provided in parallel with the tube axis as in a comparative example shown in FIG. 4B, a diamagnetic field generated in the internal magnetic shield generates magnetic flux B2, which flows toward the tube axis side and crosses the path of the electron beam 6 in the vicinity of the phosphor screen side edges 54a and 54b of the magnetic shielding members 53a and 53b, and this magnetic flux B2 generates a great Lorentz force to bend the path of the electron beam 6. On the other hand, in the present embodiment shown in FIG. 4A, since the magnetic shielding members 26a and 26b are inclined at the inclination angle θ to the tube axis so as to be spaced farther from each other toward the side of the color selection electrode 8, it is possible to narrow an angle that magnetic flux B1 generated in the vicinity of the phosphor screen side edges 51a and 51b by the diamagnetic field generated in the internal magnetic shield forms with the path of the electron beam 6. As described above, since the magnetic flux crossing the electron beam 6 can be reduced in the vicinity of the phosphor screen side edges 51a and 51b of the magnetic shielding members 26a and 26b, it is possible to prevent the electron beam path from being bent.

Furthermore, since the phosphor screen side edges 51a and 51b of the magnetic shielding members 26a and 26b are located between the color selection electrode 8 and the plane α, in other words, the distance D along the tube axis direction between the color selection electrode 8 and the phosphor screen side edges 51a and 51b of the magnetic shielding members 26a and 26b is small, the magnetic flux B1 generated in the vicinity of the phosphor screen side edges 51a and 51b hardly flows toward the tube axis side unlike the magnetic flux B2 of FIG. 4B but reaches the color selection electrode 8. Thus, since the magnetic flux crossing the electron beam 6 can be reduced further in the vicinity of the phosphor screen side edges 51a and 51b of the magnetic shielding members 26a and 26b, it is possible to prevent further the electron beam path from being bent.

Moreover, since the magnetic shielding members 26a and 26b are provided as one piece with the internal magnetic shield 21, a magnetic resistance between the internal magnetic shield 21 and the magnetic shielding members 26a and 26b is reduced. Therefore, the magnetic flux B of the tube axis magnetic field can pass through the internal magnetic shield 21 and the magnetic shielding members 26a and 26b more easily, allowing a further improvement in the shielding effect against the tube axis magnetic field.

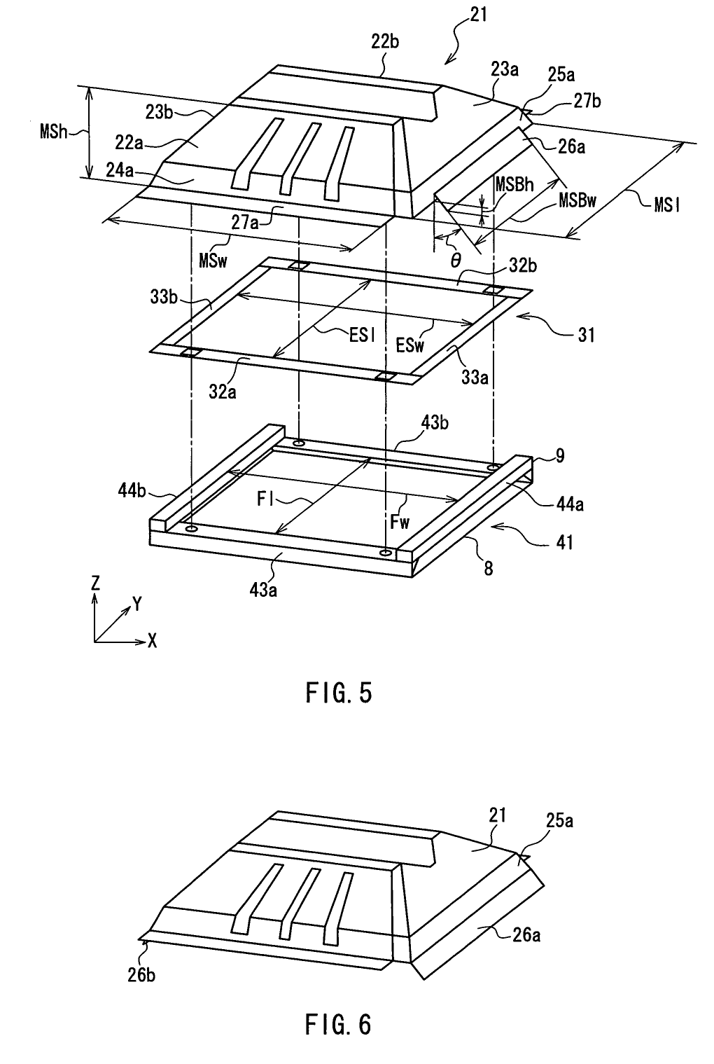

Now, the following is a description of an experiment conducted for verifying the effect of improving the magnetic shielding characteristics in the cathode ray tube according to the present embodiment. The cathode ray tube used for the experiment had a diagonal size of 76 cm and a deflection angle of 100°, and the internal magnetic shield (MS) 21, the electron shield (ES) 31 and the color selection electrode structure (F) 41 were all formed of a ferrous material. As shown in FIG. 5, the respective dimensions thereof were a length of the shorter side skirt portions 25a and 25b along the Y axis direction MSl=340 mm, a length of the longer side skirt portions 24a and 24b along the X axis direction MSw=580 mm, a height of the internal magnetic shield 21 along the Z axis direction from the horizontal skirt portions 27a and 27b MSh=180 mm, a space between the longer side portions 32a and 32b of the electron shield 31 ESl=240 mm, a space between the shorter side portions 33a and 33b thereof ESw=490 mm, a space between the pair of longer side frames 43a and 43b Fl=340 mm, and a space between the pair of shorter side frames 44a and 44b Fw=590 mm. Also, the plate-like magnetic shielding members (MSB) 26a and 26b had a length along the Y axis direction MSBw=310 mm and a projecting length along the Z axis direction from the horizontal skirt portions 27a and 27b toward the side of the color selection electrode 8 MSBh=25 mm. The only difference between Examples 1, 2, 3 and 4 according to the present invention was in the inclination angles θ of the magnetic shielding members 26a and 26b with respect to the tube axis, which were 5°, 15°, 45° and 60°, respectively. However, since the projecting length MSBh=25 mm was maintained constant regardless of the inclination angles θ in Examples 1 to 4, the distance D along the tube axis direction between the color selection electrode 8 and the phosphor screen side edges 51a and 51b of the magnetic shielding members 26a and 26b (see FIG. 3A) was 25 mm for all cases.

For comparison purposes, the magnetic shielding members 26a and 26b were not provided in Comparative Example 1, the magnetic shielding members 53a and 53b were made parallel with the tube axis (in other words, the inclination angle θ=0°) as shown in FIG. 3B and the projecting length along the Z-axis direction MSBh from the horizontal skirt portions 27a and 27b were set to be 10 mm in Comparative Example 2, and the magnetic shielding members 53a and 53b were made parallel with the tube axis (in other words, the inclination angle θ=0°) as shown in FIG. 3B and the projecting length along the Z-axis direction MSBh from the horizontal skirt portions 27a and 27b was set to be 35 mm in Comparative Example 3. In Comparative Examples 1, 2 and 3, the distance D along the tube axis direction between the color selection electrode 8 and the phosphor screen side edges of the magnetic shielding members was 50 mm, 40 mm and 15 mm, respectively. Except for the above, Comparative Examples 1 to 3 were the same as Examples 1 to 4.

In the experiment, the transverse magnetic field and the tube axis magnetic field both of 50 μT were applied to the cathode ray tube. An impact position of the electron beam on the phosphor screen before applying the magnetic fields was measured in advance, and the difference (beam shift amount) between this position and an impact position of the electron beam on the phosphor screen after applying the above-noted magnetic fields followed by degaussing was measured at four corners of the screen.

The experiment results are shown in Table 1. The values in the column of the beam shift amount in Table 1 are each relative mean values of actual measurements of the beam shift amount where 100 indicates the beam shift amount in Comparative Example 1.

TABLE 1

| | | | Beam shift amount | |
|---|---|---|---|---|
| | Inclination | | Transverse | Tube axis |
| | angle θ | Distance D | magnetic | magnetic |
| | (°) | (mm) | field applied | field applied |
| Comp. Ex. 1 | — | 50 | 100 | 100 |
| Comp. Ex. 2 | 0 | 40 | 60 | 98 |
| Comp. Ex. 3 | 0 | 15 | 40 | 95 |
| Example 1 | 5 | 25 | 50 | 80 |
| Example 2 | 15 | 25 | 50 | 70 |
| Example 3 | 45 | 25 | 50 | 65 |
| Example 4 | 60 | 25 | 50 | 65 |

As shown in Table 1, in Examples 1 to 4 according to the present invention, the beam shift amounts caused by the transverse magnetic field and the tube axis magnetic field were smaller than those in Comparative Examples 1 and 2, indicating that the magnetic shielding characteristics improved. The magnetic shielding characteristics against the transverse magnetic field of Examples 1 to 4 were slightly poorer than that of Comparative Example 3. However, it was confirmed that the magnetic shielding characteristics against the transverse magnetic field equivalent to that in Comparative Example 3 were obtained when the projecting length MSBh of the magnetic shielding members 26a and 26b was set to 35 mm (in other words, the distance D=15 mm) as in Comparative Example 3. Accordingly, it is preferable that the magnetic shielding members be provided in the vicinity of the color selection electrode with respect to the magnetic shielding characteristics against the transverse magnetic field.

Also, when comparing Examples 1 to 4, it is found that a change in the inclination angle θ of the magnetic shielding members hardly changes the magnetic shielding characteristics against the transverse magnetic field. On the other hand, the magnetic shielding characteristics against the tube axis magnetic field improve with an increase in the inclination angle θ. However, when the inclination angle θ exceeds 45°, the magnetic shielding characteristics against the tube axis magnetic field hardly change. When the inclination angle θ is increased while keeping the distance D not greater than a certain value in order to secure the magnetic shielding characteristics against the transverse magnetic field, larger magnetic shielding members 26a and 26b become necessary. Consequently, in general, when the inclination angle θ exceeds 45°, the space along the X-axis direction between the phosphor screen side edges 51a and 51b of the magnetic shielding members 26a and 26b increases, so that it becomes more difficult to mount the internal magnetic shield 21 to the electron shield 31 and the color selection electrode structure 41. Therefore, it is preferable that the inclination angle θ of the magnetic shielding members be 5° to 45°.

In the above embodiment, the magnetic shielding members 26a and 26b are welded to the lateral surfaces of the shorter sides of the internal magnetic shield 21. However, as shown in FIG. 6, the magnetic shielding members 26a and 26b (26b is not shown) also may be provided not as members different from the internal magnetic shield 21 but as one piece with the internal magnetic shield 21 by extending the plate members of the shorter-side skirt portions 25a and 25b (25b is not shown) of the internal magnetic shield 21. By forming them as one piece, it becomes possible to reduce not only the number of components but also the number of attaching processes of the magnetic shielding members. Furthermore, compared with the case of joining by welding or the like, the magnetic resistance at the border between the internal magnetic shield and the magnetic shielding members drops considerably, so that the tube axis magnetic field passes through the internal magnetic shield and the magnetic shielding members more easily, thus reducing the mis-landing further. When the beam shift amount owing to the tube axis magnetic field was measured in a similar manner to Examples 1 to 4 described above except that the magnetic shielding members 26a and 26b were formed not by welding but by extending the plate members of the shorter-side skirt portions 25a and 25b as shown in FIG. 6 (portion 25b is not visible in FIG. 6), it was confirmed that the beam shift amount in all the cases decreased by about 20%.

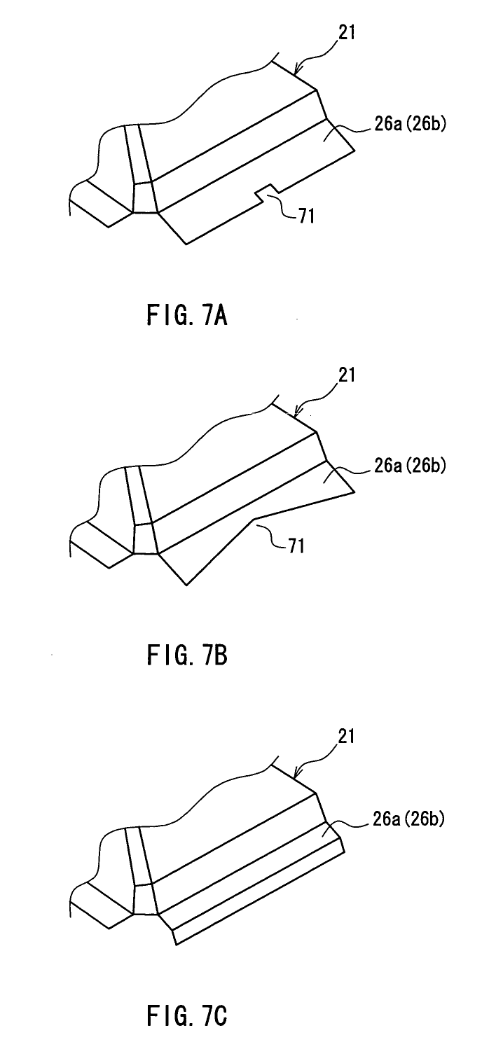

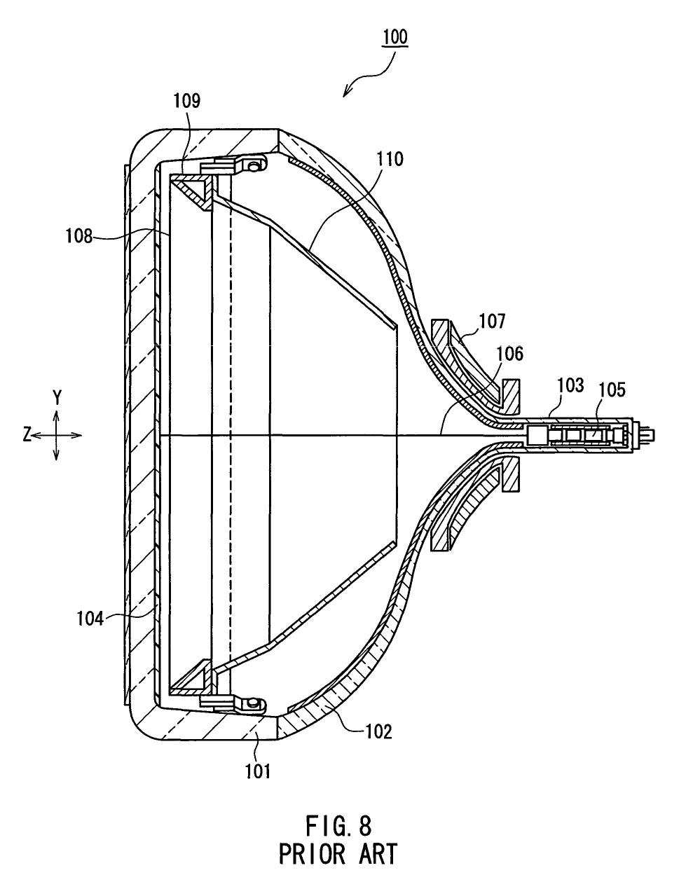

Furthermore, as other variations of the magnetic shielding members 26a and 26b, a notch 71 may be formed suitably according to a position of color displacement on the screen as shown in FIG. 7A. The number of the notches is not limited to one as shown in FIG. 7A but may be more. The shape of the notch 71 may be triangular (V shape) as shown in FIG. 7B. Also, as shown in FIG. 7C, the magnetic shielding members 26a and 26b may be bent at one or more places (for example, a multiple-folded shape such as a two-folded shape).

In the cathode ray tube according to the above-described embodiment, the color selection electrode 8 can be formed of a ferrous material so as to produce a special effect as follows.

The tension applied to a tension-type color selection electrode 8 is designed to be larger in a central portion along the X-axis direction than in peripheral portions for preventing vibration. However, since a ferrous material has a negative magnetostriction coefficient, the central portion of the color selection electrode 8 has lower magnetic characteristics than the peripheral portions thereof when the color selection electrode 8 is formed of the ferrous material. Accordingly, in the central portion, larger mis-landing is caused by the external magnetic field. Thus, by applying the above-described magnetic shielding members 26a and 26b of the present invention to the cathode ray tube using the color selection electrode 8 formed of the ferrous material, it becomes possible to prevent an increase in mis-landing. Incidentally, when the color selection electrode 8 is formed of invar, the magnetic characteristics improve by applying tension contrary to the case of the ferrous material. Therefore, the effect of improving the magnetic shielding characteristics by the present invention is very different depending on whether the color selection electrode 8 is formed of the ferrous material or invar, and a greater improvement in the magnetic shielding characteristics can be achieved in the case of the ferrous material.

Although the longer-side magnetic shield portions 22a and 22b and the shorter-side magnetic shield portions 23a and 23b constituting the internal magnetic shield 21 are all formed of bent flat plates in the embodiment described above, the present invention is not limited to this. For example, these magnetic shield portions 22a, 22b, 23a and 23b may have a curved surface with a round shape provided by press forming, and the entire internal magnetic shield 21 may be in a dome-like shape, in which case an effect similar to the above also can be obtained.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. A cathode ray tube comprising:
a panel having a phosphor screen;
an electron gun for emitting an electron beam toward the panel;
a color selection electrode having electron beam passing apertures;
a pair of longer side frames for supporting the color selection electrode with a tension being applied;
a pair of shorter side frames joined to the pair of longer side frames; and
an internal magnetic shield;
wherein magnetic shielding members further are provided on lateral surfaces of shorter sides of the internal magnetic shield,
the magnetic shielding members are inclined at an inclination angle θ (θ≠0°) to a tube axis, and
edges of the magnetic shielding members on a side of the phosphor screen are located between the color selection electrode and a plane that passes through ends of the pair of shorter side frames on a side of the color selection electrode and is perpendicular to the tube axis.

2. The cathode ray tube according to claim 1, wherein the magnetic shielding members are formed by extending a part of the internal magnetic shield.

3. The cathode ray tube according to claim 1, wherein the inclination angle θ of the magnetic shielding members to the tube axis is 5° to 45°.

4. The cathode ray tube according to claim 1, wherein a distance along a direction in parallel with the tube axis between the color selection electrode and the phosphor screen side edges of the magnetic shielding members is 30 mm or smaller.

5. The cathode ray tube according to claim 1, wherein the color selection electrode is formed of a ferrous material.
